(19) United States
(12) Patent Application Publication
(10) Pub. No.: US 2012/0228932 A1
(43) Pub. Date: Sep. 13, 2012

(54) Method and Device for Energy Management

(75) Inventors: Michael Mahler, Leinfelden-Echterdingen (DE); Friedrich Schoepf, Sternenfels-Diefenbach (DE); Markus Brandstetter, Sachsenheim (DE)

(73) Assignee: Robert Bosch GmbH, Stuttgart (DE)

(21) Appl. No.: 13/388,951

(22) PCT Filed: Jul. 27, 2010
(86) PCT No.: PCT/EP2010/060863

§ 371 Date: May 21, 2012

(30) Foreign Application Priority Data
Aug. 6, 2009 (DE) 10 2009 028 311.0

(51) Int. Cl. H02J 3/28

(52) U.S. Cl. 307/18

(57) ABSTRACT

A method for energy management optimizes loads and sources in an energy management network and includes at least one energy management unit. The actual state of the energy consumers and energy sources is transferred to the energy management unit by means of combined energy supply and communication lines. An independent configuration of the energy management unit is performed, and at least one target parameter is set on the energy management unit.

### PRIOR ART

The invention relates to a method for energy management for optimizing loads and generation in an energy management network which has at least one energy management unit.

The invention also relates to an apparatus for carrying out the method.

Energy management systems with appropriate software for optimizing energy consumption are now known for residential and commercial buildings. However, all the solutions on the market can be put into operation only with considerable installation complexity. In addition, such systems can be used only to a restricted degree.

By way of example, such solutions are based on a piece of energy management software which is connected to an installed building management system (BMS). The existing software solutions, with the existing sensors, have limited capability to sense the ACTUAL energy states of the building system which is connected to said BMS. However, automatic control using prescribed TARGET parameters does not exist. In the case of the energy management appliances being supplied on the market, for which, by way of example, the company ENNOVATIS has already achieved a high level of innovation, loads and generators need to be wired to the energy management system separately. In addition, localization information needs to be programmed in complex fashion. Furthermore, only ACTUAL states can be sensed and reproduced.

By way of example, the document DE 102004055088 A1 describes such a system for sensing and storing measurement data required for ascertaining and analyzing the consumption of a property, such as inside and outside temperature, power, gas, heating and water consumption or the like, and for controlling the consumption of the property, having a data logger, having a data analyzer, having at least one control output and having at least one interface for data interpretation, wherein all components are arranged on a single compact board. In this case, the method according to the invention provides for the system to be programmed using a programming unit (PC), as a result of which the components of said system operate autonomously. Only with considerable programming complexity is it possible to switch states according to stipulated request profiles. In addition, there is explicit provision in this case for the system to be able to be cascaded or able to be networked via Ethernet and/or via RS485 interfaces.

The patent specification US 2004 0201 279 A1 discloses DC power distribution management for a computer system, for example, which has a power management unit having controllers for monitoring the operation of the individual components, wherein information is interchanged via a control and communication bus. In this case, there is no provision for self-configuration or parameter selection. In addition, the exemplary embodiments presented concentrate on DC-DC converters with a separate bus.

Similar systems are described in the specification US 2007 0288 774 A1 and in the specification US 2008 0244 288 A1, which require a separate signal bus (signal line).

In addition, the prior art includes methods in which the switch-on and power consumption profiles, the type of the different appliances and the consumption properties thereof can be recognized with extremely high probability.

The prior art also includes data transfer applications in which data can be interchanged via the power supply lines (powerlines). Similarly, appropriate data radio links (e.g. Bluetooth) for short-range data transfer are known. Results from present research efforts also reveal that new data radio standards also support localization services in which the location of the transmitters can be localized with sufficient precision in a building.

A common feature of all the approaches to date is that the installation of the energy managers requires additional programming and information about the distribution and presence of the energy-converting installations. This gives rise to expenditures on experts, the costs of which are not covered by the attainable energy savings in many buildings. In addition, the products to date are remote from the application, since the compilation and distribution of the appliances is constantly changing particularly in commercially but also in privately used buildings.

It is therefore an object of the invention to provide a method which significantly reduces the installation complexity and particularly the programming complexity.

It is also an object of the invention to provide an apparatus which is appropriate for carrying out the method.

### DISCLOSURE OF THE INVENTION

The object relating to the method is achieved by the features of claims 1 to 12.

The object relating to the apparatus is achieved in that the energy management unit has devices for receiving an ACTUAL state of the electrical loads and of the energy generators, wherein the ACTUAL state can be transmitted via combined electricity supply/communication lines to the energy management unit and hence autonomous configuration of the energy management unit can be implemented, wherein at least one TARGET parameter can be set on the energy management unit.

In this context, the method according to the invention provides for the ACTUAL state of the electrical loads and of the energy generators to be transmitted via combined electricity supply/communication lines to the energy management unit and hence for autonomous configuration of the energy management unit to be performed, wherein at least one TARGET parameter is set on the energy management unit. The effect which can be achieved with the method according to the invention and the apparatus for carrying out the method is that the installation complexity for the energy management unit can be significantly reduced in comparison with existing approaches to a solution, since there is no need for complex programming which can normally be performed by appropriate specialist personnel only. A further advantage results from the possibility that the data transfer can be effected via the combined electricity supply/communication lines. This so-called “powerline communication” (PLC) allows additional data lines and appropriate interfaces to be dispensed with. It is therefore possible to provide a plug & play solution for end customers, which benefits broad marketing. In addition, it is possible to achieve self-customization in the event of alterations in the energy management network. A further advantage results from the possibility of setting TARGET selections directly on the energy management unit, which additionally increases user convenience.

In one method variant, the electrical loads and the energy generators are localized in the energy management network by means of an indexed appliance type and the knowledge of typical setup locations for these terminals in the energy management network. This allows the programming complexity to be reduced, since appropriate information is reported directly to the energy management unit as soon as said information is connected on the combined electricity supply/communication line.

In an alternative method variant, the electrical loads and the energy generators are localized in the energy management network by means of determination of propagation times for signals via the combined electricity supply/communication lines. This variant also allows information about the setup location of the electrical loads and of the energy generators in the energy management network to be obtained to the energy management unit with sufficient precision.

A further method variant provides for the electrical loads and the energy generators to be localized in the energy management network by means of radio location.

This can be accomplished within buildings with a precision of as good as <1 m. It should be noted that all the variants for localization can be used in parallel, which provides a particularly high level of flexibility in relation to the local circumstances and in relation to the type of generators and loads.

In respect of user convenience, one preferred method variant has provision for a plurality of TARGET parameters to be selected on a user-specific basis and to be set with a weighting relative to one another. According to need and user-dependent requirements, it is therefore a simple matter to set different selections.

It has been found to be particularly practical if the energy-consumption-relevant TARGET parameters prescribed are a value for energy costs, a value for CO₂ emission and a convenience value, respectively. It is therefore possible to initiate appropriate consumption-optimizing measures in respect of the lowest possible energy costs, the lowest possible CO₂ emission or taking account of the highest possible convenience, with appropriate weighting also being able to be used to allow for combined selection values.

In this regard, in one preferred embodiment of the invention, the TARGET parameter(s) can be set mechanically or electronically by means of control sliders using touch user interfaces, and the TARGET parameters and the ACTUAL state of the electrical loads and of the energy generators in the energy management network can be presented via a display. This setting option for the energy management unit can be used to implement graphical user guidance in a similar manner to a computer or in a similar manner to mobile telephones, which significantly increases user convenience as a result of this intuitive user guidance. Future systems will also have a voice and protection interface which takes account of the future MUI (multilingual user interface) developments.

In a relatively simple method variant, the type and the ACTUAL state of the electrical loads and of the energy generators in the energy management network are recognized from the switching characteristics of said loads and generators and a consumption per unit time is ascertained. This is particularly advantageous in the case of single-phase system design, as is the case in the USA, for example, wherein the electrical loads and the energy generators and also the energy management unit are—in the simplest form—connected to the combined electricity supply/communication line via the receptacles.

In a further preferred method variant, induction clamps are used to measure the ACTUAL state of the electrical loads and of the energy generators in the energy management network and to perform injection into the combined electricity supply/communication lines.

In addition, provision may be made for additional sensor data from sensors which are connected directly by means of intermediate receptacles between the electrical loads and on the energy generators and the combined electricity supply/communication lines or which transmit their information wirelessly thereto to be evaluated by the energy management unit. This type of linkage in the same phase as the load and the generator means that the measurement data are directly associated with the position of the load and of the generator.

As an alternative or in combination with the method variant described above, additional sensor data from radio-based sensors which send their data to reception appliances within the energy management network or directly to the energy management unit can be evaluated. In this case, it is possible to use transmission methods which permit the sensors to be localized and thereby allow the name of the location to be requested under menu guidance during installation, and the selections of the user for this location to be learned.

The method variants described above may also have provision for the energy management unit to send signals to actuators connected to the electricity supply/communication lines and/or to send radio-based signals to actuators in the energy management network. Examples of suitable actuators are roller shutter motors, ventilation flap adjusting apparatuses, locking systems, switching relays or the like which allow a reduction in consumption within the energy management network.

In addition, for the purpose of interchanging data, provision may be made for a data access interface integrated in the energy management network to be used to implement bidirectional data transfer to external data systems, wherein the data transfer is performed in wired, e.g. via the powerline, and/or radio-based, e.g. using wireless LAN, fashion. It is therefore possible, by way of example, to retrieve information about present electricity tariffs from the local electricity provider in order to optimize cost. In addition, a greater range for the energy management network is therefore made possible.

In one preferred apparatus variant, the energy management unit has reception and/or transmission devices for radio-based information from and to sensors and/or actuators positioned in the energy management network. This may involve the use of Bluetooth applications, for example.

The invention is explained in more detail below with reference to an exemplary embodiment which is represented in the figure, in which:

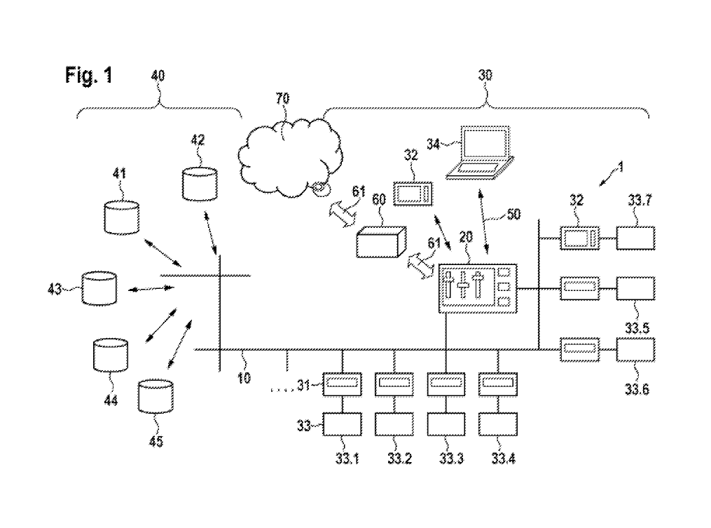

FIG. 1 shows a schematic illustration of an energy management network.

FIG. 1 schematically shows the technical environment in which the method according to the invention can be applied.

It shows an energy management network 1 which has electricity supply/communication lines 10 which are laid in different rooms 40, such as a cellar 41, a bedroom 42, a corridor 43, a living room 44 and a kitchen 45, within a building. In Europe, this is the standard 230V/220V power supply with powerline communication (PLC). In the USA, this is the standard 120V/110V power supply.

The figure also shows various pieces of electrical equipment 30 which are connected to the electricity supply/communication lines 10. In this case, connections 31 are used to connect various terminals 33 to the electricity supply/communication lines 10. Such terminals are usually large electrical loads, such as a dishwasher 33.1, a toaster 33.2, an air conditioning installation 33.3, a heating system 33.4, a heat pump 33.5 or a motor vehicle charging station 33.6 for electric vehicles, which are part of the energy management network 1, in particular.

Furthermore, the energy management network 1 includes display/web server units 32 which can be used to display a network state or which can be used to retrieve services. Thus, by way of example, provision may also be made for such a display/web server unit 32 to have the room lighting 33.7 coupled to it. In addition, at least one service access 34 is usually provided for a building, said service access being able, as shown by way of example in FIG. 1, to communicate with the energy management network 1 via a radio transmission link 50. This can also be shown by means of web services or PLC communication, as described previously, even outside of the building.

A radio transmission link 50 is beneficial particularly if certain rooms 40 or else certain sensors and/or actuators do not directly have a connection to the electricity supply/communication lines 10. Such sensors may be temperature sensors, motion sensors or humidity sensors, for example. Examples of suitable actuators are roller shutter motors, ventilation flap adjusting apparatuses, locking systems, switching relays or the like.

For the purpose of communication with external networks 70, for example with networks belonging to the energy producers, or else with appliance connections which are situated outside of the energy management network 1 which is in the building, at least one data access interface 60 (gateway) is provided which can be used for bidirectional data transfer 61 to the external networks 70 or to the appliance connections situated outside. In this case, the bidirectional data transfer 61 can be effected using DSL or using a powerline and may also be part of the energy management network 1, if not available in the building.

According to the invention, the energy management network 1 contains at least one energy management unit 20 for optimizing loads and generation in the energy management network 1, wherein the energy management unit 20 has devices for receiving an ACTUAL state of the electrical loads and of the energy generators, wherein the ACTUAL state can be transmitted via the combined electricity supply/communication lines 10 to the energy management unit 20 by means of PLC, and hence autonomous configuration of the energy management unit 20 can be implemented, wherein at least one TARGET parameter can be set on the energy management unit 20.

In this case, the energy management unit 20 may have additional features, such as reception and/or transmission devices for radio-based information from and to sensors and/or actuators positioned in the energy management network 1.

In addition, the TARGET parameters may be able to be set mechanically or electrically by means of control sliders using touch user interfaces, and the TARGET parameters and the ACTUAL state of the electrical loads and of the energy generators in the energy management network 1 may be able to be presented via a display.

The function of self-configuration is illustrated in the examples below according to the scope of application of the local energy management:

1. Optimization of Large Loads and Generators:

The energy management unit 20 is connected to the building power supply system, the combined electricity supply/communication lines 10 (powerlines), which—in the simplest form of the invention—is accomplished by means of the receptacle. This is particularly advantageous in the USA, which predominantly has a single-phase system design.

The switching characteristics of the loads and generators are used to recognize different terminals 33 and to measure the consumption per unit time. This can be used to ascertain the total energy consumption. Terminals 33 which can be switched easily can be addressed directly by means of the electricity supply/communication lines 10 using “powerline communication” (PLC). Localization is not necessary in this case. Only the user selections relating to consumptions that are to be adhered to and maximum permissible peak loads in the power supply system need to be prescribed, as is the case with electric vehicles, for example, which need to be charged in the house system using the vehicle charging station 33.5 shown in FIG. 1, so that an overload does not occur. The information about the present electricity tariffs for minimizing cost can likewise be obtained via the electricity supply/communication lines 10 and may, if appropriate, be obtained from a different external network 70 via the data access interface 60 (gateway) shown in FIG. 1.

2. Optimization of Loads and Generators Taking into Account Sensor Data from the Environment of the User (I):

This is done by proceeding as described in 1. However, sensors are now added which are arranged in direct proximity to the electrical load or to the generator. These are fitted as an intermediate receptacle between the load (e.g. refrigerator, dryer) and the generator. These sensors use the electricity supply/communication lines 10 to transmit measurement data such as temperature, humidity, brightness, presence or other input variables to the energy management unit 20. The linkage in the same phase as the load and the generator means that the measurement data are associated with the position of the load and of the generator.

3. Optimization of Loads and Generators Taking into Account Sensor Data from the Environment of the User (II):

In cases in which energy generators or loads are not localized using the sensor data, the application described in 2. has radio-based sensors added which transmit the measurement data. Examples of these data are the brightness outside for the energy consumption of the room lighting 33.7 inside of the building. In this case, it is possible to use transmission methods which permit the sensors to be localized and thereby allow the name of the location to be requested under menu guidance during installation, and the selections of the user for this location to be learned. This may involve the use of the links to the terminals 33 already found in 1. and 2.

4. Access to External Networks 70:

The applications cited above can be complemented by the option of communication with external networks 70, which can be effected either using the electricity supply/communication lines 10, using the Internet with appropriate TCP/IP or using a radio data network. This allows the external use of data for optimizing consumption and allows the attainment of a greater range for the energy management network 1.

The operation of the energy management unit 20 can be presented as below, the example below describing particularly user-friendly simple input of the TARGET parameters.

In one exemplary form of the invention and of the presentation of the user interface, the user of the energy management unit 20 is provided with the option of setting the appliance using simple slide controls. This may be in mechanical form, in electronic form or in virtual form as a touch screen. Similarly, an input option using a mobile phone or voice is conceivable. By way of example, only three objective parameters need to be prescribed for energy costs, for a CO₂ emission and for convenience. The sum of the objective parameters always amounts to 100% and is made up proportionally from the individual objective selections. Thus, by way of example, 100% energy cost optimization means that the other objective parameters must inevitably be at 0%.

When this objective is selected, the energy management unit 20 optimizes the costs of the energy required for the connected loads using the prescribed settings (e.g. internal refrigerator temperature equals 7° C.) using the available generation of electrical power (e.g. supply by the energy provider amounting to 20 cents/kWh at the moment, 15 cent/kWh from a dedicated combined heat and power unit (CHP) in 2 hours or 5 cents/kWh in 2.5 hours by virtue of wind power from a neighbor.

In this case, the energy management unit 20 also communicates with energy-generating installations which are arranged outside of the house energy management network 1. Thus, in the example cited, the available energy from wind power from a neighbor or from a dedicated combined heat and power unit is taken into account.

If the user extends the objective concerning minimized CO₂ emission (for high energy efficiency) by 25%, for example, then the cost optimization would be withdrawn to a proportion of 75%. The energy management unit 20 would strive not only for energy cost reduction but also for measures to minimize the CO₂ emission.

The method and the apparatus can be used to provide an efficient energy management system, in particular, for residential and commercial buildings.

1. A method for energy management for optimizing loads and generation in an energy management network which has at least one energy management unit, comprising:
transmitting the ACTUAL state of the electrical loads and of the energy generators via combined electricity supply/communication lines to the energy management unit;
performing autonomous configuration of the energy management unit; and
setting at least one TARGET parameter on the energy management unit.

2. The method as claimed in claim 1, further comprising:
localizing the electrical loads and the energy generators in the energy management network by means of an indexed appliance type and the knowledge of typical setup locations for these terminals in the energy management network.

3. The method as claimed in claim 1, further comprising:
localizing the electrical loads and the energy generators in the energy management network by means of determination of propagation times for signals via the combined electricity supply/communication lines.

4. The method as claimed in claim 1, further comprising:
localizing the electrical loads and the energy generators in the energy management network by means of radio location.

5. The method as claimed in claim 1, further comprising:
selecting a plurality of TARGET parameters on a user-specific basis; and
setting the plurality of TARGET parameters with a weighting relative to one another.

6. The method as claimed in claim 5, wherein the TARGET parameters prescribed are a value for energy costs, a value for CO₂ emission and a convenience value, respectively.

7. The method as claimed in claim 1, further comprising:
recognizing the type and the ACTUAL state of the electrical loads and of the energy generators in the energy management network from the switching characteristics of said loads and generators; and
ascertaining a consumption per unit time.

8. The method as claimed in claim 1, further comprising:
measuring the ACTUAL state of the electrical loads and of the energy generators in the energy management network with induction clamps; and
performing injection into the combined electricity supply/communication lines with induction clamps.

9. The method as claimed in claim 1, further comprising:
evaluating additional sensor data from sensors which are connected directly by means of intermediate receptacles between the electrical loads and on the energy generators and the combined electricity supply/communication lines or which transmit their information wirelessly thereto by the energy management unit.

10. The method as claimed in claim 1, further comprising:
evaluating additional sensor data from radio-based sensors which send their data to reception appliances within the energy management network or directly to the energy management unit.

11. The method as claimed in claim 1, further comprising:
sending signals to actuators connected to the electricity supply/communication lines with the energy management unit; and/or
sending radio-based signals to actuators in the energy management network with the energy management unit.

12. The method as claimed in claim 1, further comprising:
implementing bidirectional data transfer to external data systems using a data access interface integrated in the energy management network; and
performing the data transfer in wired and/or radio-based fashion.

13. An apparatus for energy management comprising:
at least one energy management unit configured to optimize loads and generation in an energy management network,
wherein the energy management unit includes devices for receiving an ACTUAL state of the electrical loads and of the energy generators,
wherein the ACTUAL state can be transmitted via combined electricity supply/communication lines to the energy management unit, and hence autonomous configuration of the energy management unit can be implemented, and
wherein at least one TARGET parameter can be set on the energy management unit.

14. The apparatus as claimed in claim 13, wherein the energy management unit further includes reception and/or transmission devices for radio-based information from and to sensors and/or actuators positioned in the energy management network.

15. The apparatus as claimed in claim 13, wherein:
the TARGET parameter(s) can be set mechanically or electronically by means of control sliders using touch user interfaces, and
the TARGET parameters and the ACTUAL state of the electrical loads and of the energy generators in the energy management network can be presented via a display.
